(19) United States
(12) Patent Application Publication
(10) Pub. No.: US 2013/0103510 A1
(43) Pub. Date: Apr. 25, 2013

(54) SYSTEM AND METHOD OF GATHERING AND DISSEMINATING DATA ABOUT PROP, WARDROBE AND SET DRESSING ITEMS USED IN THE CREATION OF MOTION PICTURE CONTENT

(71) Applicant: ANDREW TILLES, STUDIO CITY, CA (US)

(72) Inventor: ANDREW TILLES, STUDIO CITY, CA (US)

(21) Appl. No.: 13/360,783

(22) Filed: Jan. 29, 2012

Related U.S. Application Data
(60) Provisional application No. 61/548,724, filed on Oct. 19, 2011.

(51) Int. Cl. G06Q 20/20; G06Q 30/06

(52) U.S. Cl. 705/17; 705/26.61

(57) ABSTRACT

A system and method of gathering data about the wardrobe and properties items purchased for use in the production of motion picture content which data can then be disseminated to viewers/consumers along with the motion picture content for marketing, promotional and commercial purposes. Purchase transaction data and production information is collected during the purchase transactions of props, set dressing items and wardrobe by authorized key purchasing production personnel during production of motion picture content using an assigned purchase card such as a credit card, debit card or petty cash card. Product information so gathered is then linked to the specific motion picture content being produced using the specific purchase card account numbers. The product information associated with the motion picture content is then disseminated to the viewing public via a website on the internet. Interested viewers are thereby able to identify and purchase similar items.

### CROSS-REFERENCE TO RELATED APPLICATIONS

This non-provisional utility patent application claims the benefit of the provisional patent application No. 61/548,724 filed Oct. 19, 2011 by Andrew Noel Tilles.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

During the production of motion picture content, such as theatrical films, television programming, television commercials or other video, the written script is used as the starting point for the plan of how the motion picture will be made. The motion picture studio or production company acquires the rights to the script and, after evaluating and analyzing the viability of the script and the potential profitability of the produced motion picture content, invests the money to create the motion picture content based upon the script. Generally, the production studio or company retain the copyright to the finished motion picture work and contracts with one or more distributors to distribute the work in one or more media channels and territories, such as broadcast television, DVD, satellite television, theatrical exhibition, etc. The copyright owner retains all ancillary rights including remake rights, merchandising rights, etc.

Once the script material is approved for production, the production entity first hires a producer and director. Director interprets the written script and begins to visualize the action, tone, drama and visual presentation of the written story. Producer and another subsequent important hire, the production manager, will begin to break down the script to determine the number of actors and extras needed, the number of location shooting days, stage shooting days, etc. Director and producer assemble a team of production personnel to select, acquire, store and manage the plethora of products, set adornment property and wardrobe which will be used in the creation of the motion picture content.

Art directors and set designers are selected by the director and producer to manage the building of stages and choosing location settings where the action will take place. If a production will be shooting in a real location, the set design team may only be populating the existing location with furniture or whatever set dressing may be required or dictated by the script and the director of the motion picture. Art director and set designer will hire a team of individuals to assist in the designing, building, creation and furnishing of the sets. Depending on the requirements of the director and the script, the set dressing items may be originally manufactured from scratch, rented from a set dressing rental facility or purchased from an existing retail or wholesale establishment.

Costume designers and wardrobe supervisors are selected by the director and producer to provide the clothing that the actors will be wearing during their on-camera performance. Costume designers and wardrobe supervisors will hire a team of individuals to assist in the design, creation and/or selection of the clothing which will be used to clothe the actors during their performance. Depending on the requirements of the director and producer, the clothing items may be designed and created from scratch, rented from a wardrobe rental facility or purchased from an existing retail or wholesale clothing establishment.

The property master is hired to supervise the acquisition and organization of the various props that the actors will need to use during their performance. Props are distinguished from set dressing due to the level of interaction they receive from the actors during the performance. A hand prop, such as a smoking pipe, hand tool or can of soda is something that the actor will manipulate during the scene. Depending on the type of prop and the requirements of the director and script, the props may be manufactured from scratch, rented from a property rental facility or purchased from an existing retail or wholesale facility.

The production of the motion picture content commences when all the various pieces are assembled and ready for principal photography including the actors, sets or locations, wardrobe, set dressing, props, etc. Motion picture cameras using film or video and sound recording devices are used to capture the action and dialogue.

Once principal photography is complete, the photographed images are assembled during the editorial or post production process. Some additional photography may be needed during this stage as well as visual effects, post production sound work, music and titles.

Once the motion picture content is complete it will be distributed in any number of media including theatres, DVD, television, satellite, internet, etc.

In many instances, viewers of the finished motion picture content are interested to learn more about and/or possibly purchase the set dressing pieces, props or wardrobe items they have seen on screen. However, no viable and cost effective or efficient means of gathering and organizing and disseminating this information has yet been devised. Thus, viewers who are interested have no means of determining the source of items they see appearing on screen in motion picture content let alone purchasing similar items for themselves. The disclosed invention aims to cost effectively and efficiently organize data about the items used in the production of motion picture content which data can then be disseminated to the interested viewer of the content.

### BRIEF SUMMARY OF THE INVENTION

This invention provides a system whereby information about the materials and physical objects acquired for use in the production of the motion picture content by the production personnel can be gathered, organized, tracked and disseminated. The purpose of gathering, organizing and presenting this information is primarily to allow viewers of the motion picture content to obtain information about the physical objects appearing in the motion picture content. It is well documented that viewers of motion picture content have a keen interest in the apparel, accessories, set adornment, etc. that appear on screen in popular motion picture content. This dissemination of the information about said physical objects would provide an additional revenue stream for the content creator/copyright holder in the form of potential commissions on ultimate sales of similar products based upon a product's appearance in the motion picture content. In addition, the content creators could charge fees to manufactures and retailers of said products for promotion in the motion picture content—even in the absence of any direct sales of the product.

The information about the products purchased for use in the creation of the motion picture content is gathered by the use of a point-of-sale plastic card which could be a credit card, debit card or petty cash card. These cards are distributed to the production personnel who are charged with the task of finding and acquiring the props, wardrobe and set dressing items. These key purchasing production personnel use these assigned cards exclusively to purchase the necessary items from any number of retail or wholesale establishments. The retailer or wholesaler is provided with a list of the card accounts and uses the discreet card account number to identify, isolate, aggregate and transmit transaction and product data based on the purchase transactions using said card. The data from the retailer's database about the product and sale transaction is transferred to an entity established to implement the invention disclosed herein. The established entity provides the detailed information about the purchase transaction to the motion picture production entity. These data would include time and date of purchase, retailer, store location, stock keeping unit number (SKU#), UPC#, price and perhaps even a digital photograph of the product. This information from the retailer about the transaction would be voluntarily released by the retailer as a form of digital receipt for the purchase of these items. The entity established to implement the invention would work on behalf of the motion picture production entity to gather and organize the data. The entity established by the invention herein could merely provide the data to the motion picture entity for the motion picture entity to exploit or utilize. In addition, the entity itself could work on behalf of the motion picture entity to exploit the information by establishing and maintaining a virtual store online where items used in the production and appearing on screen in the production could be made available for sale to the viewer via a website created specifically for the motion picture content produced. The online store would not actually sell the article of clothing or prop used in the show itself. The online store would sell identical individual units of the article used in the production of the motion picture content. The data may also be embedded into the motion picture content to be transmitted along with the content to be exploited via interactive television, mobile applications and so forth.

This system is more readily suited for items purchased by production personnel from established retailers and wholesalers who have agreed and registered to provide the information to the entity formed herein. However, the production company or studio can also provide information to viewers about items rented from rental facilities for incorporation into the production. In addition, items such as original specialized clothing created specifically for a specific character in a specific program can be subsequently mass-produced and sold by the production company, if demand for the product warrants.

The disclosed method and process do not lend themselves readily to motion picture content that is historical or period in nature. Nor, does it lend itself to science fiction or futuristic motion picture content. This is because, in these cases, more of the items seen on screen are created originally and specifically by the motion picture production entity and are generally not available in mass produced quantities from existing retailers and wholesalers.

### BRIEF DESCRIPTION OF THE DRAWINGS

FIG. 1 is a prior art organizational diagram of a typical entertainment industry production company for use as an example of the disclosed invention.

FIG. 2 is an upper level systems overview of the system and method of the disclosed invention.

FIG. 3 is detailed view of the data exchange between the retailer, the aggregator and the production entity.

FIG. 4 is a typical database record showing all the information gathered and linked by the aggregator as a result of the disclosed invention.

### DETAILED DESCRIPTION OF THE INVENTION

It is assumed, though not essential, that an entity separate from the retailer, the financial institution and the production entity will be established to implement the invention disclosed herein. This is because of the amount of time and expertise required to obtain authorizations and permissions, to integrate databases from various sources, to organize data and properly disseminate data so that it can be exploited. However, the data aggregator entity could be established as a sub-entity of a credit card processor such as VISA® or Mastercard®. Or, an entity could be formed within an existing production studio or media conglomerate such as Walt Disney, Fox or Warner Bros. Our drawings assume the entity established by the invention disclosed herein to be a separate entity called the aggregator.

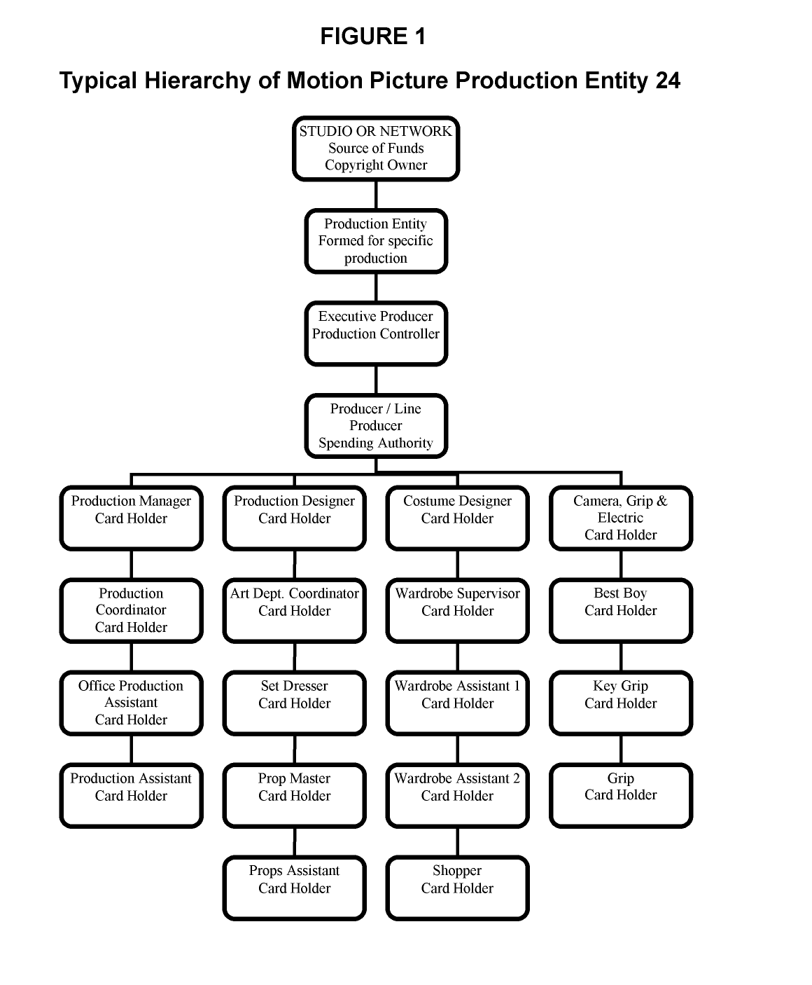

FIG. 1 shows a generalized view of the structure of the personnel employed in the motion picture creation and production process. At the top is the studio or network. The studio or network funds the production of the motion picture content and as a result generally owns the copyright in and to the completed motion picture content as well as all licensing and merchandising rights in and to the motion picture content produced. A production entity is generally formed to execute the production-related activities of the motion picture content creation which includes the several stages of the production process: script development, pre-production, production, post-production. Many crew members are hired at the various stages to oversee and execute the various processes involved in the production. Most significant for the description of the invention disclosed herein are the Art Department which includes the areas of set construction, set dressing and properties as well as the Wardrobe Department which is involved with establishing the wardrobe for each character in each scene.

The Wardrobe and Art Departments are overseen by creative personnel such as the Production Designer and Costume Designer. Further down the hierarchy, employees such as Wardrobe Assistants or Shoppers (in the case of the Wardrobe Department) are responsible for actually acquiring the wardrobe that will be worn by the characters as they appear on-camera in the motion picture content. Similarly, in the Art Department, employees toward the bottom are responsible for actually acquiring the props and set dressing items which will ultimately appear on-screen in the finished production under the direction and approval of their respective superiors and ultimately the director. Note that the disclosed invention and system is only useful for production of motion picture content which takes place during the present day. Period productions or futuristic science fiction productions will generally design and create original props, set dressing items and wardrobe from scratch. They will not acquire them from established retailers or wholesalers. For the purposes of the disclosed invention, each of the employees working on acquiring props, set dressing or wardrobe items is issued a credit card, debit card or petty cash card by the motion picture production entity with which to make purchases of items that will be used in the production of the motion picture content. The employees are required to maintain accurate records to substantiate their purchases using the company-issued cards.

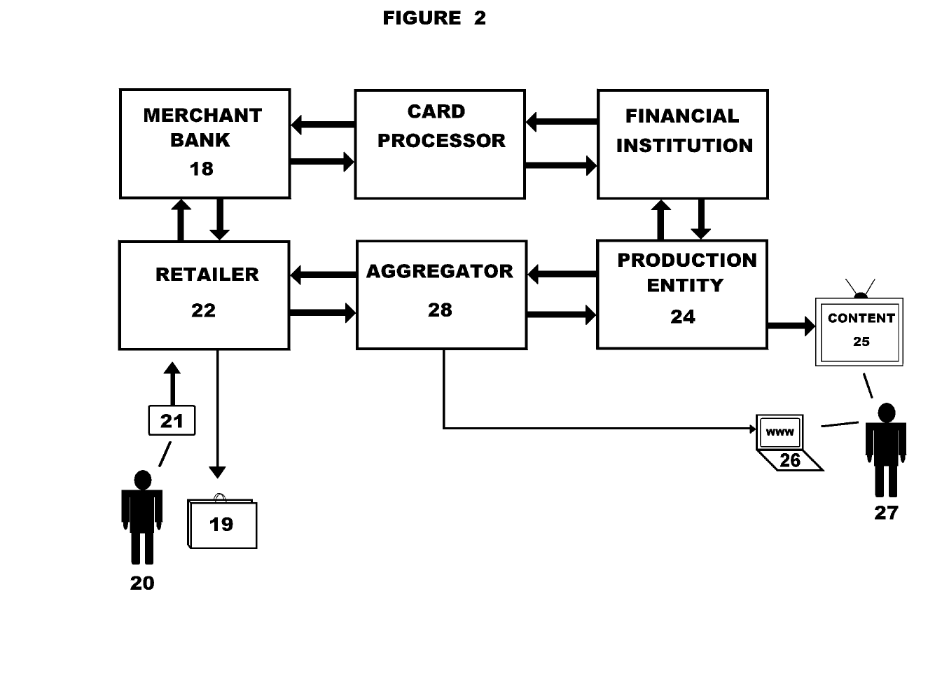

FIG. 2 shows the generalized overview of the system of the current invention. The central entity in the system is the aggregator 28 which implements the novel aspects of the invention. Note that the data aggregator can also be formed a sub-entity of a credit card processing company or the motion picture finance and distribution entity.

First, the production entity 24 will be formed and staffed to carry out the production of the program 25. The employees of the production entity 24 will be issued a point-of-sale (POS) card 21 by the company for the purposes of making production-related purchases for the production. The point of sale card could be a petty cash card, a debit card or a credit card under an account established by the production entity. Each card will have a discreet account number and the production entity will record and keep track of which employee in which department is using which card. The production entity will closely monitor the purchases made by its employees using the card.

The production entity registers with the aggregator 24 using a web-based secure online registration system. During this registration process, the production entity provides general information about itself such as contact information, information about the motion picture content 25 being produced, as well as information about the specific employees who will be making purchases of items which will ultimately be seen on screen, such as prop department employees and wardrobe department employees. The production entity provides the names and POS card account numbers of these key purchasing production personnel to the aggregator. Though POS cards may be issued to many employees working on the production, only purchases made by those employees providing items which will ultimately appear on-screen in the motion picture content will be identified by the production entity and registered with the aggregator. So, purchases made by office production assistants using company-issued POS cards of office supplies for the production office, for example, will not be registered by the production entity with the aggregator.

Each POS card is issued to the specific employee and the card account number is recorded by the production entity so as to identify the purchases and associate or link them to a specific department of the production: wardrobe, props, set dressing, etc. A further specification could be implemented whereby a specific POS card could be issued and used by one or more employees for purchases related to a specific discreet sub-area of the production. For instance, a certain POS card could be used solely for purchases of clothing for a specific character. Or, a specific card could be used solely for the purchase of set dressing for a specific set such as, for example, the main character's apartment. Such specification will provide for more ease in identifying, organizing and transmitting the data about specific items purchased and the ultimate use of the products on screen in the motion picture content. Purchasing employee or employees may then be assigned more than one POS card and be responsible for using the correct POS depending on the item being purchased.

The employee 20 working for the production entity 24 purchases an item 19 from a retailer 22 at the retailer's normal retail establishment using the point of sale card 21 to make the purchase.

Retailer 22 records the information about the transaction as they normally would during the course of regular business including, but not limited to, the date and time of sale, the store location, item purchased, Stock Keeping Unit (SKU) or Universal Product Code (UPC) number, style, description of item, quantity purchased, retail value of purchase, sales tax paid, salesperson number, customer name, customer card account number, etc. Retailer 22 provides all the necessary information to its merchant bank 18 in order to obtain payment for the items purchased in the transaction. Retailer 22 also provides this information to aggregator 28. The retailer has been registered in advance with and by the aggregator and has agreed to provide to the aggregator additional data about the transaction which is not necessarily required for payment. Such data includes but is not limited to product SKU number or UPC code, manufacturer, brand or label, country of origin, store location, digital photograph of the product will be provided by the retailer 22 to the aggregator 28 in addition to the cardholder name and POS card account number.

The production entity employee 20 then takes the purchased merchandise item 19 back to the wardrobe or prop storage area at the production entity for later use during production of the motion picture content. During the course of production, the purchased item 19 will be brought to the set or used on the actor during the shooting process. The image of the item 19 will be incorporated into the motion picture content.

Aggregator 28 has also registered and established an account with production entity 24. Aggregator acquires information from the production entity 24 about the program 25. This information includes the name of the studio, distributor, production entity, and title of the television program or feature film. The production entity also provides the aggregator with the specific purchase card account numbers it has issued to each employee along with the employee's position with the production entity: wardrobe assistant, set dresser, etc. Additionally, the production entity may assign a specific card to be used solely for the purchase of specific wardrobe items for a specific character. This information will be provided to aggregator and periodically updated by the production entity, as necessary.

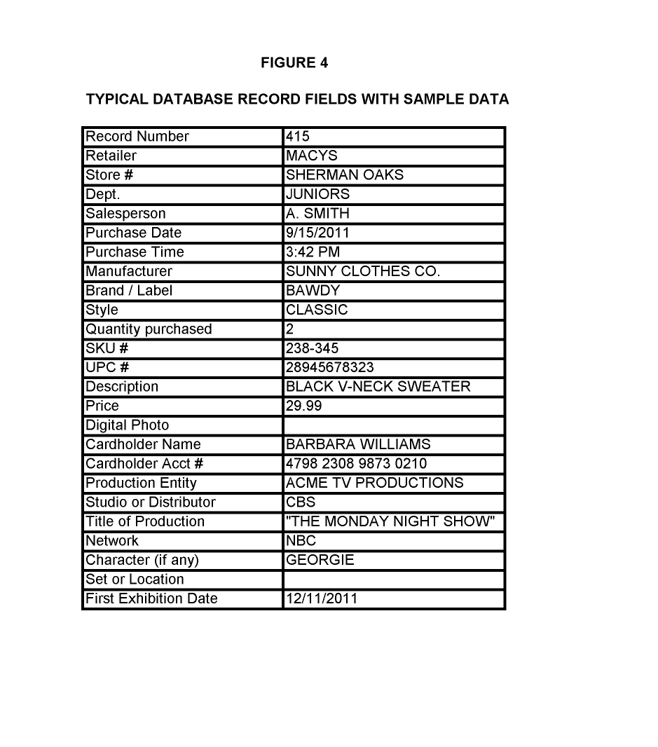

The aggregator 28 gathers and integrates all the data about the transaction and the products purchased for use in the specific production. The aggregator uses the POS card account numbers to reference the purchase transactions for specific products purchased for incorporation into specific motion picture content by the production entity 24. Each individual transaction forms an individual record in a database. The database links the POS card account number to the specific item purchased. In this way, the products purchased are linked to the production and the motion picture content. An example of a typical database record generated by the aggregator 28 can be seen in FIG. 4.

This information can then be provided to the production entity 24. The production entity 24 can disseminate this information to the viewing public via its own website or other means. The assumption herein is that the production entity 24 will contract with the aggregator to provide dissemination services including website construction and maintenance, product sale transaction processing, product fulfillment, etc. The aggregator may buy and hold an inventory of merchandise for sale to the public based on the items identified in its database. More likely, the aggregator will create a website which can process transactions to be fulfilled by the original Retailer 22 that sold the product to the production personnel in the first place.

The program 25 is then distributed via motion picture theatrical exhibition, broadcast television, cable television, motion picture download or streaming, etc. to the viewer 27. The information about all the products incorporated into the program 25 is also disseminated to the viewer 27 via a website 26. Hyperlinks and industry-standard shopping cart and check out purchase website interfaces incorporated into the website will allow the viewers to purchase the products and merchandise seen on screen in the program.

Additional uses for this database of product information by the production entity 24 would be for valuation of holdings for financial, accounting and insurance purposes, inventory control and production management such as during re-makes, sequels, re-shoots and other visual continuity maintenance.

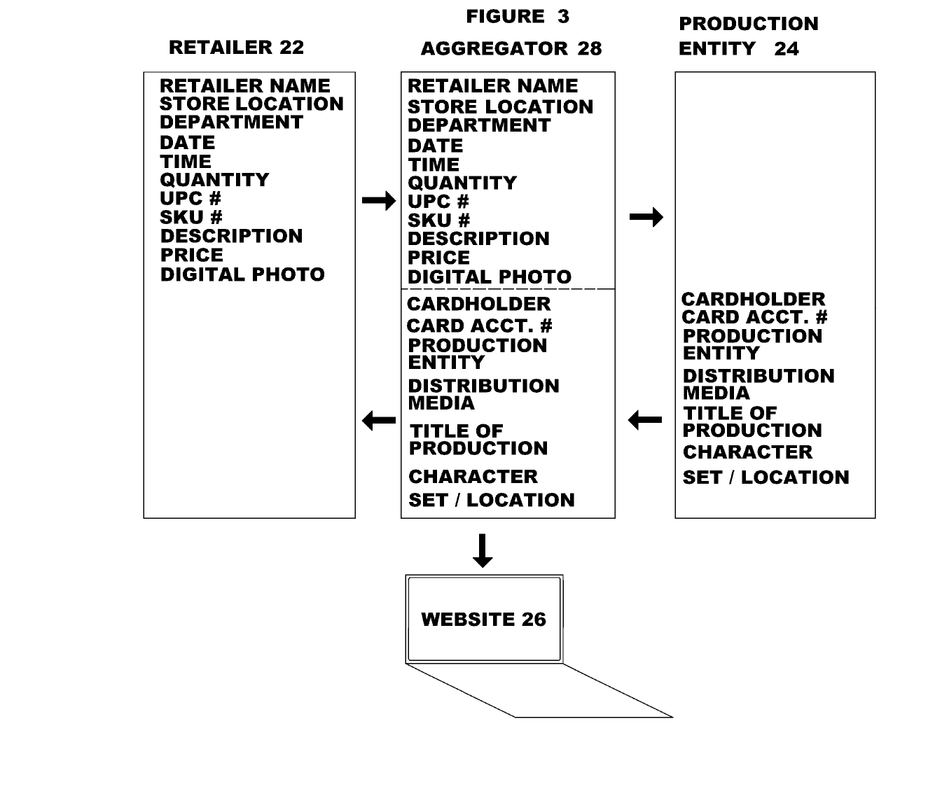

FIG. 3 shows the data which will be gathered by the aggregator 28 from the retailer 22 using the POS card account number provided by the production entity 24 to reference specific purchase transactions. The aggregator will acquire the data from the retailer and cross reference the POS card number to the specific key purchasing production personnel of the production entity. This will allow a master database to be created which will itemize all the props, set dressing and wardrobe items acquired for use in the production of the motion picture content by the production entity. Note that the aggregator will be the clearing house of information about many different productions working with many different production companies and accessing data from many thousands of transactions at many different retail and wholesale establishments. As shown in FIG. 3, the aggregator 28 will provide the information acquired about the purchase transactions by the production personnel to the production entity 24. This will enable the production entity to use the data for record-keeping purposes including accounting and financial purposes, insurance purposes and maintenance of production continuity.

FIG. 4 shows a typical database record created by the aggregator by combining the data collected from the retailer with the information acquired from the production entity. This database will be used to provide the information to the viewing public about the items included on-screen in various productions including wardrobe and accessory items, set dressing items and props.

The aggregator will disseminate the database information via a website which will comprise separate pages or a separate website for each specific production. Items for a specific production will be further segregated based on the product category such as women's blouses, furniture items, women's accessories, etc. If a separate POS card account has been established for purchases of clothing for a specific character, then those items can be further segregated onto a separate website page. Each specific product listing on each web page will allow an interested viewer to purchase the item via an internet hyperlink connection to the product purchase page at the original retailer's website or via a standard web-based shopping cart and check out purchasing method.

Those skilled in the art will recognize the powerful commercial potential of the invention disclosed herein especially in light of the continuing expansion of the use of the internet for the transmission and exhibition of long form motion picture content.

1. I claim a system and method whereby information about the articles and objects appearing on-screen in motion picture content can be identified, collected, organized, catalogued and disseminated or presented so that interested motion picture content viewers can ascertain specific information about the props and wardrobe items seen on-screen and potentially purchase similar items comprising:
The establishment of a data aggregator to implement the disclosed invention which entity will register production studios or production companies as well as retailers and wholesalers to participate in the process disclosed herein;
A registration system whereby a production entity provides to the data aggregator general information about itself and the motion picture content being produced including company name, address, phone number as well as names and point-of-sale (POS) card account numbers assigned to key purchasing production personnel responsible for acquiring products to be used as set dressing, properties and wardrobe during the production of said motion picture content and authorizes said aggregator to collect, maintain and disseminate said information;
A retailer and wholesaler registration system whereby the retailer provides general information about itself and authorizes said data aggregator to receive, gather, organize and disseminate information about specific purchase transactions made by said key purchasing production personnel using said assigned POS card accounts issued to the key purchasing production personnel by the production entity;
A virtual private computer network which allows said registered retail or wholesale establishment to transmit said data about specific purchase transactions made by said key purchasing production personnel using said specifically assigned POS cards to said data aggregator;
Said virtual private network also allows said data aggregator to provide to said registered retail or wholesale establishments those specifically assigned POS card numbers being used by said registered production entity's key purchasing production personnel in order to determine which data about which specific purchase transactions are to be identified, segregated and collected by said registered retailer and transmitted to the data aggregator;
A virtual private computer network which allows said registered production entity to communicate with said data aggregator in order transmit and update data about the motion picture content being produced including information about the specific POS purchase card accounts being used by said key purchasing production personnel including update, additions and deletions of said POS card account numbers;
Said virtual private computer network connection will also allow said data aggregator to provide information to the registered production entity about specific products purchased by key purchasing production personnel for use in the production of said motion picture content, said information to be used for accounting, insurance, archiving, re-shoots and continuity and any other purpose for which said registered production entity might deem valuable, including disseminating said data via the production entity's own website;
A public website or other form of product information dissemination whereby the data aggregator provides information to the viewing public about the specific products seen on-screen within the motion picture content and used as set dressing, properties or wardrobe and accessories said website to allow interested motion picture content viewers to learn more about individual products incorporated into the motion picture content and to purchase said items over the internet.

2. The method of claim 1, wherein the production studio or company assigns key purchasing production personnel specific point-of-sale (POS) plastic purchase cards such as debit cards, credit cards or petty cash cards, said cards to be exclusively used by said production personnel as assigned by said registered production entity in order to allow said retailer or wholesaler to indentify the purchases made by said key purchasing production personnel.

3. The method of claim 1, wherein said key purchasing production personnel use said specific POS purchase card assigned to him or her by said registered production entity for the purchase of goods to be used as props, wardrobe and set dressing items in the production of said production entity's motion picture content.

4. The method of claim 3 whereby, as a further means of identification and isolation of specific items purchased, said key purchasing production personnel may be assigned several POS cards wherein a separate POS card is to be used to make purchases of items for one specific aspect of the production of the motion picture content such as one specific character's wardrobe or the set dressing of one specific character's main set thus providing for greater specificity and more isolated identification of specific items used in the production of said motion picture content.

5. The method of claim 1, wherein said registered retailer or wholesaler identifies, collects and segregates data about the purchase transactions made by key purchasing production personnel of said prop and/or wardrobe items to be used in the production of said motion picture content using said specific POS card account number(s) provided to the retailer by the data aggregator and subsequently transmits said purchase transaction and product information to the data aggregator, said information comprising, but not limited to, the manufacturer, brand or label, make, model, style, color, size, SKU, UPC, country of origin, description of item, fabric or material contents, digital product image, date of purchase, location of purchase, retail price and any other relevant transaction and product data collected by the registered retailer.

6. The method of claim 1, wherein said registered production company or studio transmits information to said data aggregator; said information to include, but is not limited to, general information about the motion picture content being produced, number of episodes, distribution network, planned date of first exhibition, etc. as well as specific information about the key purchasing production personnel and their respectively assigned POS purchase card account numbers including any updates, additions, cancellations and/or other necessary changes thereto.

7. The method of claim 1, whereby the data provided by said registered retail or wholesale establishment about the specific purchase transactions is associated with or linked to said registered production entity's motion picture content using said unique assigned POS card account numbers used by said key purchasing production personnel to identify said purchase transactions and the items so purchased thus creating a master database of information about said items so purchased which database includes all information about the product so purchased, information about the purchase transaction, and information about said motion picture content being produced.

8. The method of claim 1, whereby said product and purchase transaction information in said data aggregator's database about said items purchased using said POS cards by said key purchasing production personnel and incorporated in said registered production entity's motion picture content is disseminated and presented to the motion picture content viewer/consumer in the form of a web site, interactive television data stream, mobile device data stream, or other mechanism which would allow the viewer/consumer to obtain information from said master database about said prop and/or wardrobe items used in or seen on-screen in said motion picture content and to purchase similar items.

9. The method by which unique POS card account numbers which have been assigned to key purchasing production personnel of a motion picture production entity are used by a data aggregator or other similar entity, a registered production entity and a registered retail establishment to identify, collect, segregate, organize and transmit specific information about purchase transactions and information about the products so purchased and provide said information to the viewing public.

10. The method of claim 9 by which said registered retail or wholesale establishment identifies, segregates, collects and organizes information about specific purchase transactions and the information about the products so purchased using the uniquely assigned POS card account numbers provided to said retailer by said data aggregator or other similar entity.

11. The method of claim 9, whereby said registered retail or wholesale establishment transmits to said data aggregator or other similar entity via a secure computer network connection said information about said purchase transactions and information about the products so purchased by said key purchasing production personnel using said uniquely assigned and identified POS card account numbers.

12. The method of claim 9, whereby said motion picture production entity obtains said POS purchase card accounts from a financial institution and assigns them to key purchasing production personnel and requires them to exclusively use the assigned POS cards for all purchases of props, set dressing and wardrobe items whenever possible.

13. The method of claim 9, whereby said motion picture production entity identifies, segregates and organizes data about the specific POS card account numbers assigned to key purchasing production personnel.

14. The method of claim 12, whereby a specific POS card or cards are assigned by said motion picture production entity for purchases of a specific character's wardrobe items or for purchases of specific set dressing items for a specific character's main set.

15. The method of claim 9, whereby said registered motion picture production entity transmits said data about POS card account number assignments to said data aggregator or other similar entity over a secure web-based computer network.

16. The method of claim 15, whereby administrative personnel from said motion picture production entity register with said data aggregator or other similar entity and provide data about specific POS card account numbers and the key purchasing production personnel assigned to each POS card account including updates, cancellations, additions and deletions of card accounts using a secure web-based user interface.

17. The method of claim 9, whereby the data aggregator uses the POS card account numbers assigned to key purchasing production personnel to link the data provided to it by the registered production entity and the data provided to it by the registered retailer or wholesale establishment to create a master database of information about the items purchased by the key production personnel employed on the production of a specific motion picture for incorporation into that specific motion picture content.

18. The method by which the data aggregator or other similar entity disseminates the information in said data aggregator's database via the internet to the viewing public via a website to allow viewer/consumer to learn more about the products or items seen on screen in the motion picture content and to purchase said products or items.
